(19) United States
(12) Patent Application Publication
(10) Pub. No.: US 2014/0040021 A1
(43) Pub. Date: Feb. 6, 2014

(54) METHOD AND SYSTEM OF SUBSIDIZING eBOOKS IN EXCHANGE FOR INCLUDING ADVERTISING FROM BRAND IDENTIFIED COMPANIES

(71) Applicants: Stuart Beckley Coleman, New York, NY (US); Jeremy Sterns, New York, NY (US)

(72) Inventors: Stuart Beckley Coleman, New York, NY (US); Jeremy Sterns, New York, NY (US)

(21) Appl. No.: 13/566,866

(22) Filed: Aug. 3, 2012

(51) Int. Cl. G06Q 30/02

(52) U.S. Cl. 705/14.49

(57) ABSTRACT

A method of one or more sponsors using a computing device connected to a network to subsidize one or more eBook titles including receiving one or more eBook titles and first descriptions of preferred sponsors from first representatives of one or more publishers; receiving brand assets and second descriptions of preferred eBook content from second representatives of the one or more sponsors; selecting based on the first and second descriptions at least one eBook title and at least one sponsor for sponsoring the at least one eBook title; and inserting at least one advertisement formed on a basis of the brand assets received from the at least one sponsor into the at least one selected eBook title to form at least one sponsored eBook edition.

### FIELD OF INVENTION

The present system relates to subsidizing cost of literary works in eBook format in exchange for adding brand assets including brand identified companies' logos and other brand related images in digital form.

### BACKGROUND OF INVENTION

Societies develop and improve when people freely share their knowledge and views. This sharing is achieved through writing, publishing, distributing, buying and reading of books and other collections of writings like magazines and newspapers. Throughout history the proliferation of books, and therefore knowledge and views embodied in them, was limited to our ability to duplicate the books, which depended on the available technology. At certain points in time, a convergence of circumstances and technology greatly increased the ability to duplicate books therefore placing the books in the hands of larger numbers of people. Such convergences included proliferation of monasteries in Medieval Europe where monks reproduced the Bible and other works including Greek and Roman classics. This duplication method was very time consuming and relatively expensive. The introduction of the printing press dramatically increased the variety of publications and lowered the price of their duplication enough to make these publications affordable to a larger number of persons. This further enabled many more authors to publish, sharing their thoughts and experiences and generate an income in the process.

More recently a convergence of the Internet, communication, and computer technologies had a similar powerful impact on publishing by enabling access to digital books (eBooks) in any language to almost every person in the world. Where book stores or libraries didn't exist only a few years ago, people can now access most world publications in eBook and similar digital forms via an Internet connected computer. However, the requirement of being connected to the Internet tethered the reader to the Internet access point. This drawback was corrected when eBook readers or eReaders, pocket size processor based devices, were developed. eReaders severed the tethers tying eBook readers to homes, schools and libraries, enabling storage of enormous digital libraries in the pocket size devices so as to enable borrowing or purchasing and reading of almost any eBook anywhere: at home, work, school, on a train, taxi, subway, at an airport or on the plane, in a park or on the beach. eReaders and the books they store can now be taken wherever people go, including places where the Internet or other means of communication are not available.

Dramatic growth of eBook sales is documented in FIG. 1, where in less than ten years the sales were driven 1000 fold. eReaders are a good example of how, once a technology hits its tipping point and adoption starts to soar, consumers develop new habits. Amazon introduced its Kindle eReader in 2007 and launched a larger-screen version in 2009. But it wasn't until around the time Apple introduced the first iPad in 2010 that the eBook explosion began. The latest statistics from the American Association of Publishers (AAP) show that eBook sales rose 138% in 2011, and experts expect the trend will continue as a larger and larger share of the population acquires eReaders, iPads and other tablet computers that can function as eReaders.

According to one estimate (HIS iSuppli, March 2012), tablet shipments will increase 90% by the end of 2012. But it's not just that sales are soaring; behavior is changing. According to a March 2012 Harris poll, 28% of U.S. adults now read on eReaders or tablet computer. This is up from 15% from July 2011. They are also reading a lot more than other people. A 2012 Pew study found that eBook users consume an average of 24 books a year vs. 15 books a year for other readers. According to the study, “Some 41% of tablet owners and 35% of eReading device owners said they are reading more since the advent of e-content.”

The above-discussed developments made eBooks generally available and more affordable. The transition from print to digital media, including eBooks, pressured publishers to reduce the price of eBooks beyond what made them and their authors comfortable. eBooks are generally cheaper than their printed counterparts, because (1) the duplication cost is almost nonexistent and (2) consumers expect digital media to be cheaper than printed media. Still, there is a large segment of readers who may find this cost difficult to afford or view eBooks as overpriced. Some eBooks are made available through the on-line libraries for borrowing; however, borrowing of eBooks is not suited to foster more authors to make a living from sharing their ideas and thoughts.

Thus, two concurrent issues need to be resolved. First, with readers demanding lower prices and the widening impact of eBooks, publishers are getting squeezed out of existence. However, the cost of eBooks must stay at a level where publishers and authors, especially those lesser known who rely on income from their art, can reach a wide audience without having to invest heavily in advertising costs.

Second, the price of eBooks must be made more affordable for a large segment of readers who find it difficult at times to pay full price. In print magazines and newspapers, publishers use advertisements to help increase the income from the sale of the publications. However, diverse advertisements of different products will be distracting to a reader of, for example, a novel or a text book.

Thus, what is needed is a way to (1) offer readers a more affordable way to purchase and enjoy eBooks, (2) create a unique new environment for the brand identified companies to tell their stories, and (3) generate incremental income, drive more sales and diversify revenue streams for the publishers, permitting them to continue to earn enough revenues so that they are able to produce the high quality books that consumers desire.

### SUMMARY OF INVENTION

It is an object of the present system to overcome disadvantages and/or make improvements in the prior art.

Accordingly, the inventors introduce a method and system to subsidize eBooks in a manner that can help decrease its prices. Advertisements or brand assets from the brand identified companies are incorporated into the eBooks' experience. For this inclusion of brand assets, the publishers receive a subsidy. The subsidy may enable the publishers to offer the eBook at a lower price. Thus, instead of the reader having to pay the full price of the eBook, the brand identified company may exchange money with the publisher for advertisement impressions in the eBook.

This system of multiple engagements with the eBook allows the brand identified company to tell their brand's story over a long period of time to readers who will repeatedly return to the brand assets as they progress through the eBook. Additionally, when a single brand identified company sponsors the eBook, there are few distractions from other brands while the reader is engaged with the eBook. Due to the exclusivity of the medium, a brand identified company is afforded a one-to-one relationship with the reader. This arrangement provides the brand identified company many impressions throughout the eBook which presents the brand in a positive manner to an appreciative reader who pays less for the subsidized eBook.

Provided is a method of one or more sponsors using a computing device connected to a network to subsidize one or more eBook titles including receiving one or more eBook titles and first descriptions of preferred sponsors from first representatives of one or more publishers; receiving brand assets and second descriptions of preferred eBook content from second representatives of the one or more sponsors; selecting based on the first and second descriptions at least one eBook title and at least one sponsor for sponsoring the at least one eBook title; and inserting at least one advertisement formed on a basis of the brand assets received from the at least one sponsor into the at least one selected eBook title to form at least one sponsored eBook edition.

### BRIEF DESCRIPTION OF DRAWINGS

The invention is explained in further detail, and by way of example, with reference to the accompanying drawings wherein:

FIG. 1 is a graph indicating growth in eBook sales from 2002 to 2011;

FIG. 2 is a diagram illustrating various network connected devices interacting with the exchange server of a preferred embodiment of the present system;

FIG. 3 is a diagram illustrating interaction of the exchange server and the external devices shown in FIG. 2;

FIGS. 4a-4e are diagrams and screenshots illustrating the actions performed by representatives of a publisher in accordance with the preferred embodiment;

FIG. 5 is a diagram illustrating actions performed by representatives of a brand identified companies an in accordance with the preferred embodiment;

FIGS. 6a-6b are diagrams and a screenshot illustrating formation of a campaign by the exchange server in accordance with publishing workflow for sponsored eBooks of the preferred embodiment;

FIGS. 7a-7b are diagrams illustrating start and end of the campaign by the server in accordance with publishing workflow for sponsored eBooks of the preferred embodiment; and

FIG. 8 is a diagram illustrating the components making up the server and the devices interacting with the server in accordance with the preferred embodiment.

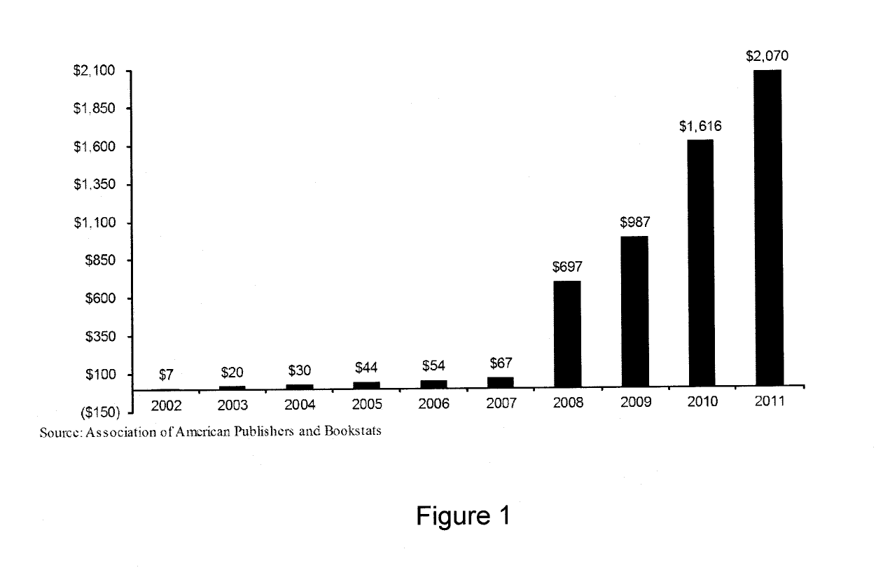

### DETAILED DESCRIPTION OF INVENTION

The following are descriptions of illustrative embodiments that when taken in conjunction with the following drawings will demonstrate the above noted features and advantages, as well as further ones. In the following description, for purposes of explanation rather than limitation, illustrative details are set forth such as architecture, interfaces, techniques, element attributes, etc. However, it will be apparent to those of ordinary skill in the art that other embodiments that depart from these details would still be understood to be within the scope of the appended claims. Moreover, for the purpose of clarity, detailed descriptions of well known devices, tools, techniques and methods are omitted so as not to obscure the description of the present system. It should be expressly understood that the drawings are included for illustrative purposes and do not represent the scope of the present system. In the accompanying drawings, like reference numbers in different drawings may designate similar elements.

For clarity, the preferred embodiment will be described with placement of brand assets from one brand identified company per eBook. The brand assets may be represented by magazine and online newspaper style advertisements from the brand identified company. The advertisements may be placed, for example, between chapters of the eBook being sponsored. The advertisements tell the story of the brand identified company, thus, a single story of the brand can be told within the eBook or different stories at different chapters providing more chances to connect with the reader who returns to the advertisements as he or she reads the eBook.

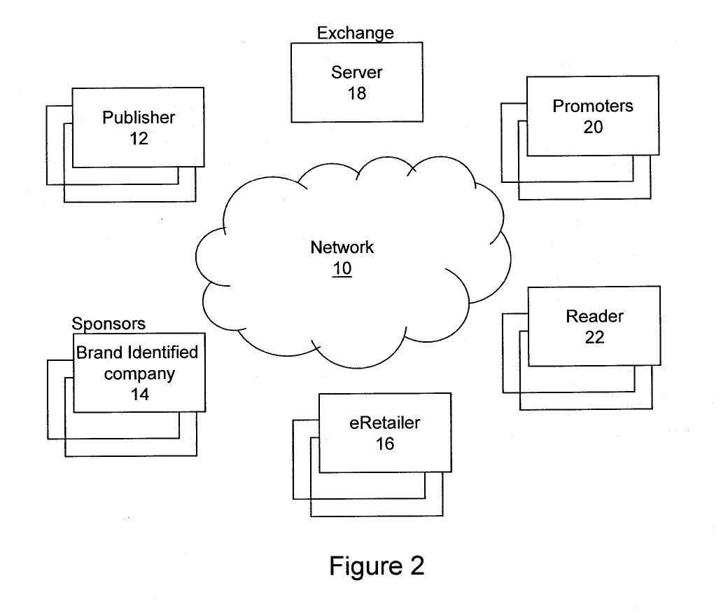

Referring to FIG. 2, an embodiment of the present system includes a network 10, for example a wide area network, the Internet, 3G and 4G cellular networks, or any similar network that enables communication between diverse computing systems at various locations. Connected to the network 10, wired or wirelessly, is at least one exchange server 18 on which the acts of the method of the inventive system that is described below are performed. Similarly connected to the network 10 are one or more devices 12 used by representatives of publishers of eBooks and one or more devices 14 used by representatives of brand identified companies for accessing the exchange server 18 to provide the necessary information and items as described below. Also connected are one or more promoter systems 20 that execute marketing product promotions independently and in cooperation with one or both of the publishers and brand identified companies.

Further connected to the network 10 are one or more eRetail systems 16, which may be websites or locations, accessible via the network 10, e.g., the Internet, where eBooks are sold to readers. These websites allow readers using computing devices 22 including eReaders (described below) to browse/search for eBooks and then purchase them. In addition to browsing/purchasing eBooks, the websites, in particular the inventive website, enable the readers to connect to friends (for example via Facebook Connect or other social networks). Further, the invention enables the readers to view these friends' eBook purchases using bookshelves. The bookshelves record information about individual reader's reading progress and habits as they relate to particular books. If enabled for viewing by others, the bookshelves show this information including when the reader who owns the bookshelf read the eBook, reader's comments, highlights, ratings, reviews, and statistics related to their reading of the eBook. Also, the bookshelf may accept recommendations for eBooks from others, which may result in the recommender receiving benefits if the bookshelf owner purchases the recommended eBook, for example points that can be used towards future purchases. Similarly, the eRetail systems' websites may reward readers for certain reading achievements, such as a number of words, pages, books read, or a number of books from a certain category read, for example books by the same author, etc. These reward can be made available as part of the bookshelf's information to be showcased in the profile of the reader.

Once purchased, the eBooks are accessed via eReaders. In one embodiment this eReader includes an ability to display eBooks of multiple formats, for example, ePub and PDF. As is well known, the eReader is accessible via the network 10, e.g., the Internet connected devices, such as tablet and desktop computers, mobile phones, etc. Additionally, it can be accessed when offline (not connected to the Internet). The eBooks read on the eReader may be stored on the device itself or on network accessible storage, known as the cloud. One feature of the eReader using the cloud is that if a reader stops reading on a certain page of an eBook and picks up reading on another device, another eReader, mobile phone, or other devices, the eBook opens up to the same page where the reader left off.

In another embodiment, the eReader allows the reader to highlight the text as well as store comments. It also enables the reader to look at their reading progress statistics, such as words read per minute, pages read, time of reading, number of reading sessions, etc. The eReader can also provide more information on the author, title, and topics addressed in the book. The statistics and information are accessed by requesting the Reader to switch from displaying the eBook to a user interface that enables access to the statistics and information, pictures, and videos, which may be uploaded via the network 10 from sources such as Wikipedia, YouTube, author websites, etc., when the eBooks are purchased from the eRetailer systems 16 or afterwards. When the reader is finished with viewing the statistics and information, the user interface can be manipulated to take the reader directly back to the page they were reading. This ability to switch from reading to view other materials can be exercised throughout the reading experience.

In another embodiment, the user interface of the inventive eReader allows the reader to opt to share statistics of their progress and other information collected by the eReader. It is understood, that any and all options can be “opt out”. For example, as a default the statistics are automatically shared and an option, if selected, enables the reader to share their statistics manually or not at all. Additionally, the user interface enables the readers to view the progress of other readers who opted to share their progress, statistics, comments and highlights. This viewing can be enabled at any time or as the reader finishes the page which other readers have highlight or commented on. Further, the user interface enables the eReader to directly message other readers who opted to share individually or in a selected reading group.

In one embodiment, the eReader may be enabled to display advertisements, for example, in the form of a banner horizontally or vertically across any one of the margins at top or bottom of every page or on selected pages. At different pages, for example at every page, or every number of pages, the selection of margins on which advertisements are displayed may be changed. Thus, the reader is getting a different impression for at least every page they are viewing. In return for viewing the advertisements displayed by the eReader, the reader may receive a payment, for example, in the form of points that can be used to buy specified products like eBooks from participating eRetail systems 16. Therefore, extended reading leads to earning of more points.

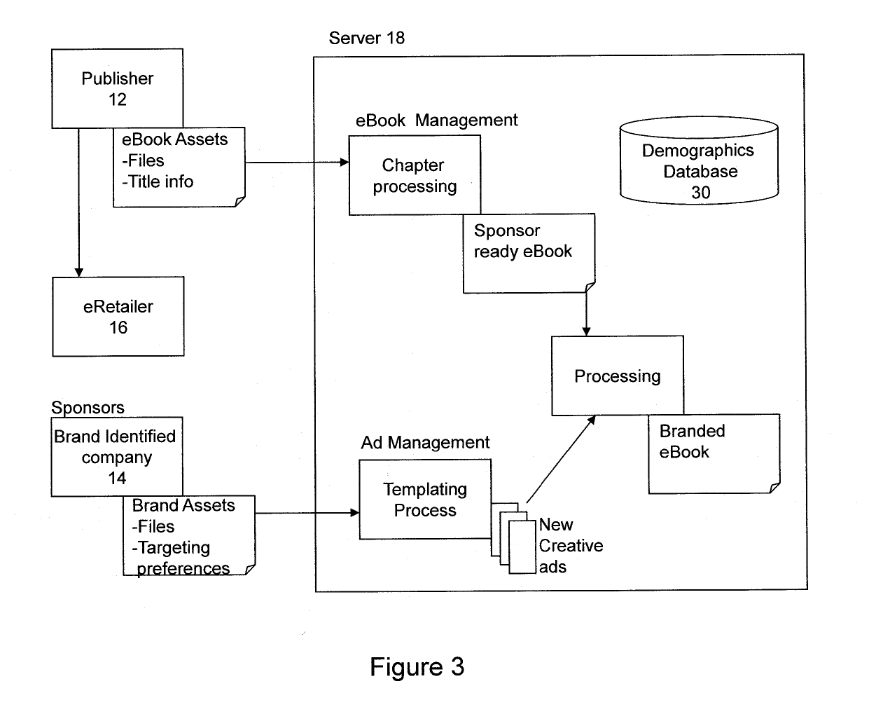

Turning to FIG. 3, to participate in the exchange an author of a literary work can have a contractual relationship with a publisher for representation. Alternatively, a self publishing author may choose to represent him or her self. For purposes of this specification, such authors will also be addressed as publishers. In either case, before proceeding the representative of the publisher using devices 12 agrees to terms for participating in subsidizing/sponsorship. Upon receipt of this agreement, in accordance with the preferred embodiment, the exchange server 18 receives the actual literary work or eBook titles in a digital format accepted or pre-approved by the exchange server 18, proof of ownership, and any preferences for brand identified companies from the representative of the publisher. It is imperative that a permission to make advertising insertions within the eBook titles is provided by the representatives of the publishers, other right holders, or their representatives. However, there are situations where an author's consent/permission isn't required, that may be, for example, in situation where the contract does not include the clause requiring consent.

### Enrollment for Sponsorship

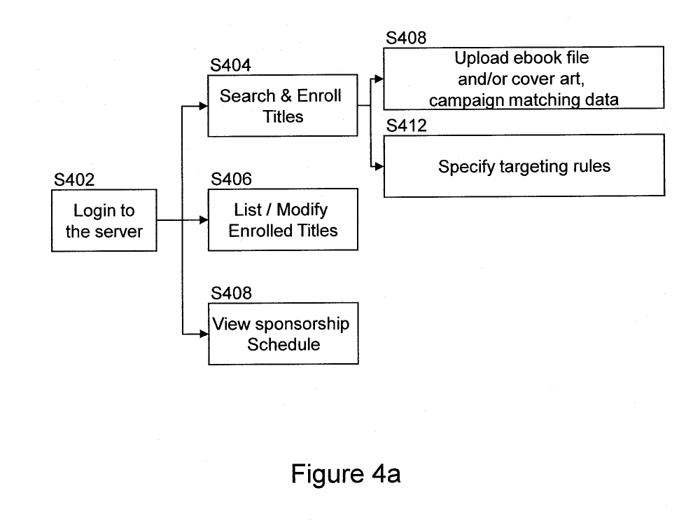

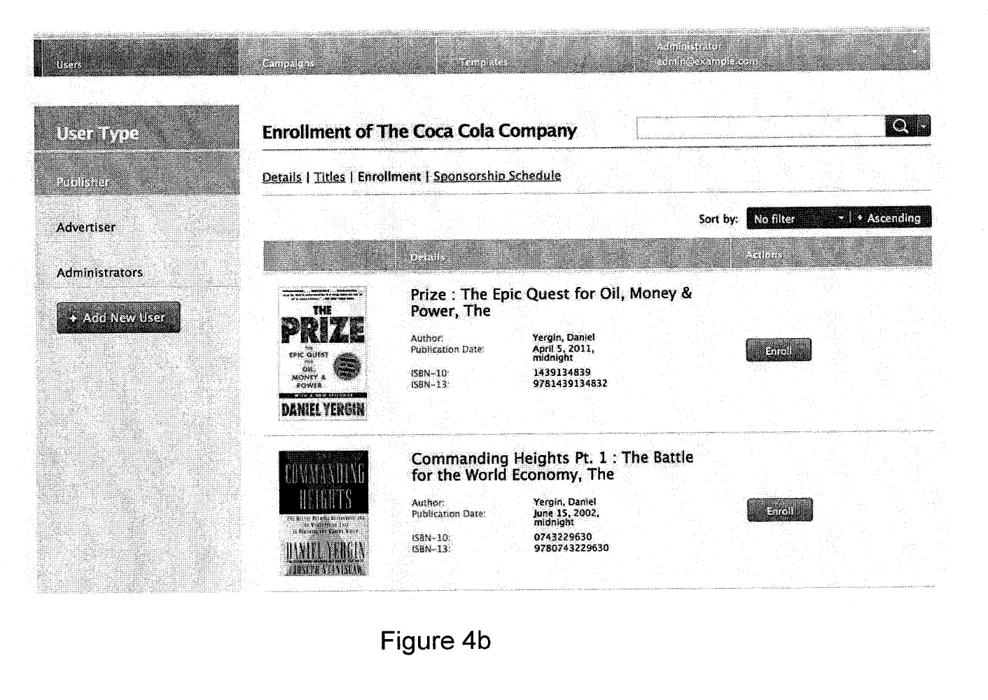

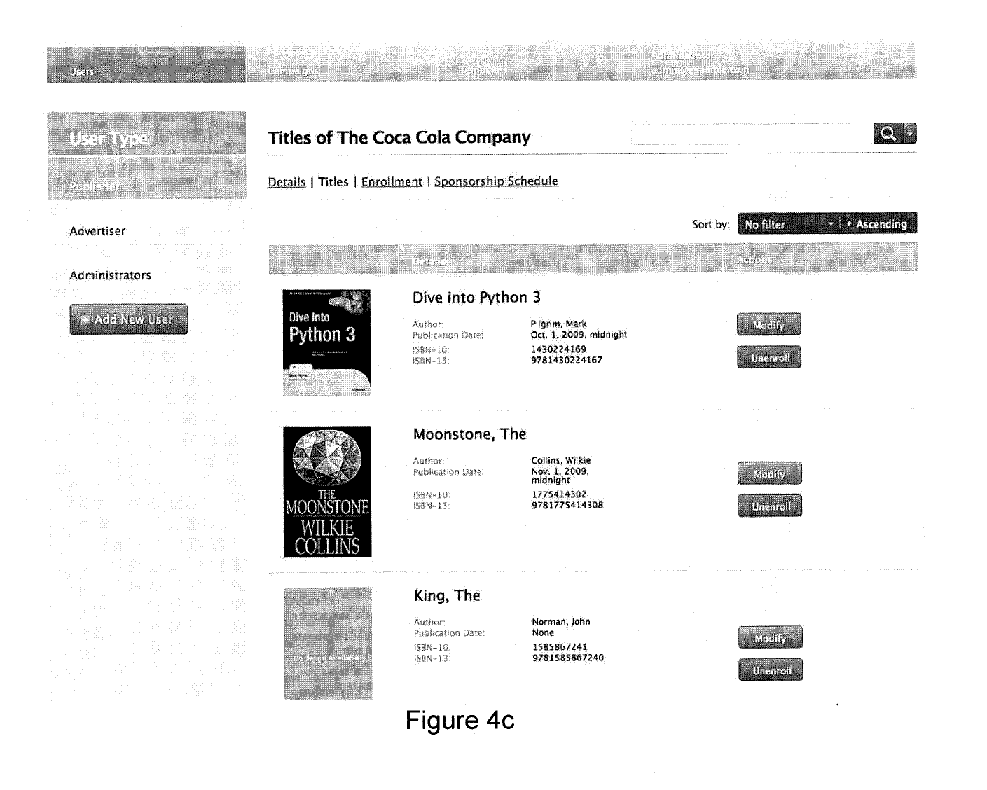

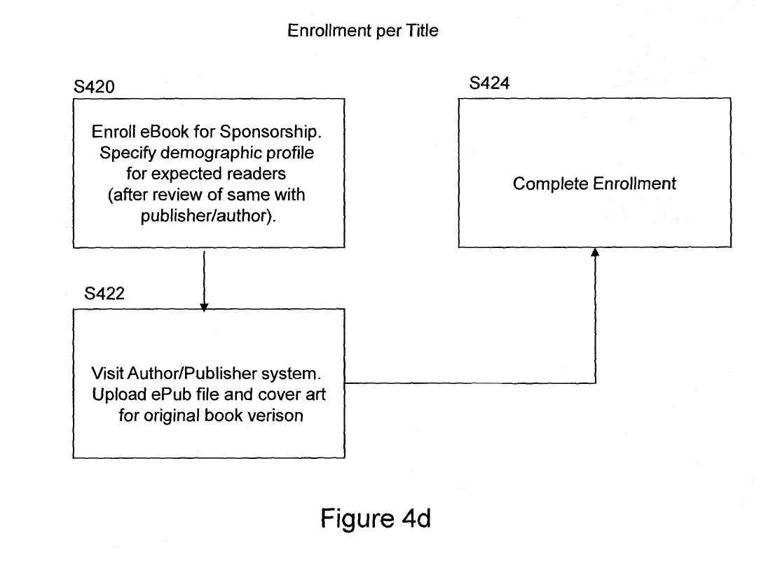

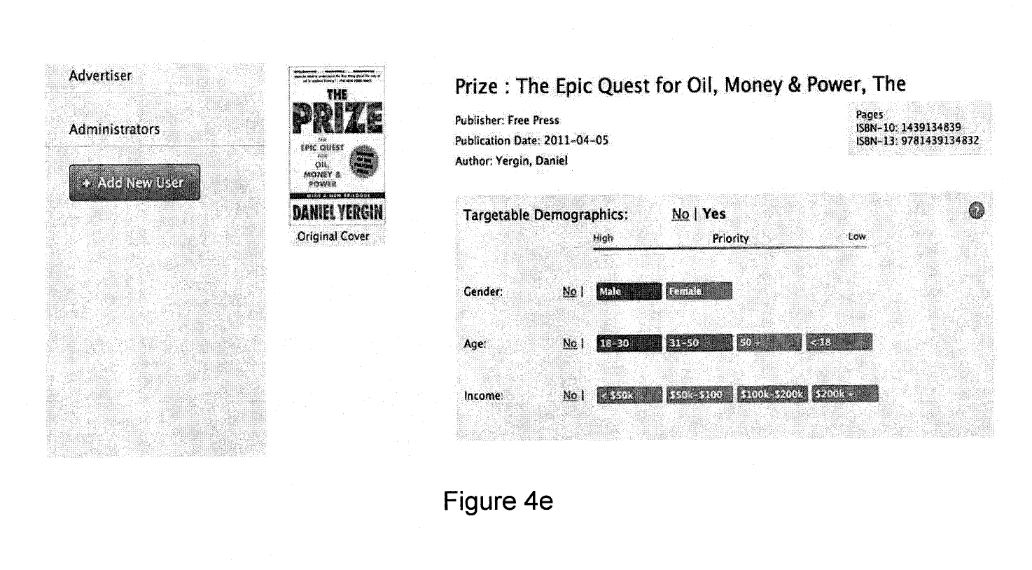

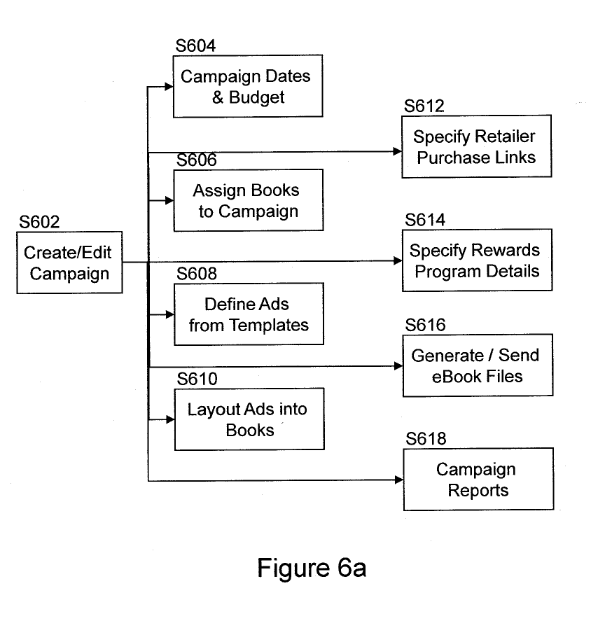

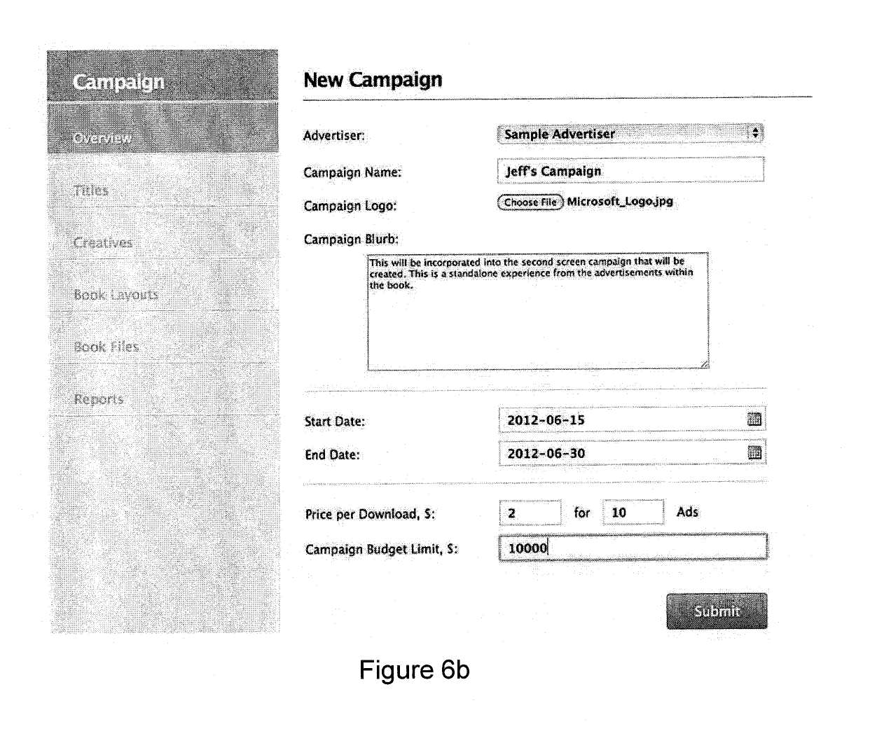

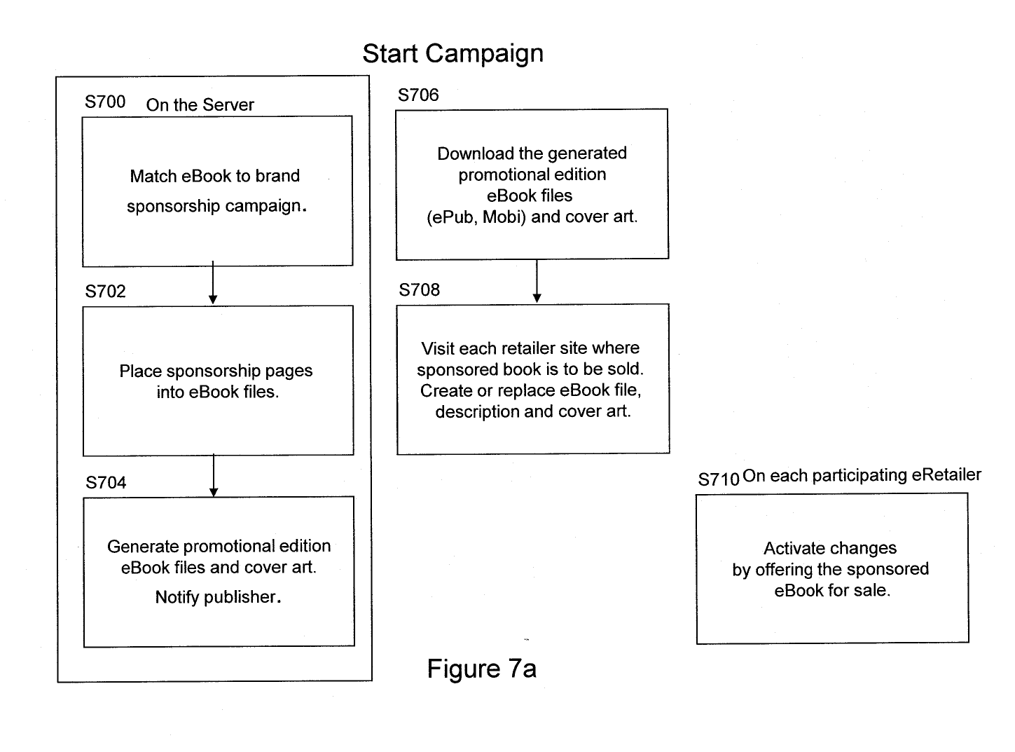

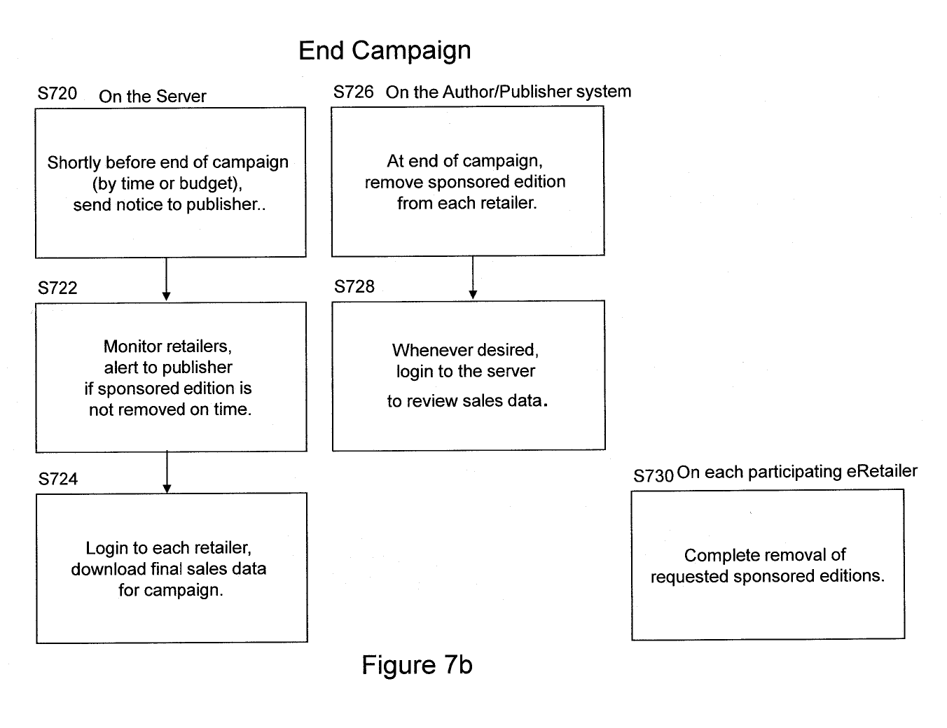

In one example illustrated in FIG. 4a at step S402 the server 18 enables the representative of the publisher using devices 12 to login or connect to the server, at step S404 to enroll new eBook titles for sponsorship (FIG. 4b), and to search if previously enrolled books have found sponsors. The enrollment is supplemented at step S410 by uploading an eBook file and/or any cover art as well as any campaign matching data. Campaigns are described below with reference to FIGS. 6 and 7. In addition, at step S412 the representative of the publisher using devices 12 can specify its targeting rules, if any. The targeting rules include targetable demographics criteria; for example, men, age 25-40, who are adventure oriented. This allows the enrolled eBooks, which reach the specified audience, to be targeted. Note that when the eBooks are enrolled for sponsorship in the exchange server 18, they are assigned classifying metadata indicating their target readership. As illustrated in FIG. 4b, the enrollment can be for sponsorship by a specific company (e.g., Coca Cola). Alternatively, the enrolled eBook title may be selected by the brand identified companies or their representatives. The exchange server 18 enables the representative of the publisher to prioritize different demographic category data. The demographic selections are force-ranked, but not mandatory for the enrollment process. The targetable demographics are specified so that later, as described below, that eBook can be matched or found by a representative of the brand identified company who desires to sponsor eBooks that appeal to certain reader demographics.

When performing enrollment, the representative of the publisher enters eBook identifying information into the database 30 (FIG. 3) and then selects and enrolls the eBook titles from the database 30. In one embodiment, the enrollment process is made is easier by enabling the representatives of the publishers to populate the database 30 (FIG. 3) by a feed from a book industry data source, for example from the ProQuest affiliate Bowker. Once the database is populated, the representative of the publisher simply selects the titles from the database where all the relevant required information is pre-stored. By incorporating the feed, it is simpler for the representative to enroll their eBooks for sponsorship, rather than entering or typing in all the information about the eBook (e.g., author name, publisher name, date of publication, number of pages, and a description of the eBooks' contents). The exchange server 18 enables database searches based on all commonly searched fields including, Title, Author name, or Publisher name.

At step S406, as illustrated in FIG. 4c, all the eBook titles enrolled for sponsorship can be listed for viewing. The listed titles are approved for sponsorship and, thus, are available to be matched for sponsorship campaigns. Campaigns are described below. The exchange server 18 enables the representatives of the publishers to un-enroll or withdraw some or all of the listed titles and/or modify any related information. At step S408 the sponsorship schedule can be displayed. The sponsorship schedule indicates, from the publisher's perspective, which of the publisher's eBooks are scheduled for sponsorship, for what period of time, by which brand identified companies, etc.

Turning to FIG. 4d, at step S420, the exchange server 18 verifies receipt of all the enrollment information from the representative of the publisher, and enrolls the eBook for sponsorship in accordance with the known related demographic profile, which is maintained, for example in the database 30 (FIG. 3) or elsewhere (e.g., by independent services on the Internet). In one embodiment, the representative of the publisher may be enabled to review and approve the demographic profile. Where the representative of the publisher fails to approve this profile, alternative demographic profile may be proposed. In one exemplary embodiment the demographics for a particular eBook title may be presented as illustrated in FIG. 4e, indicating gender, age, and income among other parameters. Returning to FIG. 4d, upon securing approval of the demographics selection, at step S422 the server 18 retrieves all the files related to the eBook including the original digital publication and related cover art. At this point, as indicated in step S424 the enrollment is complete.

### Sponsors

Returning to FIG. 3, the representatives of prospective sponsors access the exchange server 18 using devices 14. The sponsors are the brand identified companies, the owners or leasers of the brands, companies such as Coca-Cola, Pulsar, Apple, or their representatives (e.g., advertising or media agencies). The sponsors are independent from the publishers.

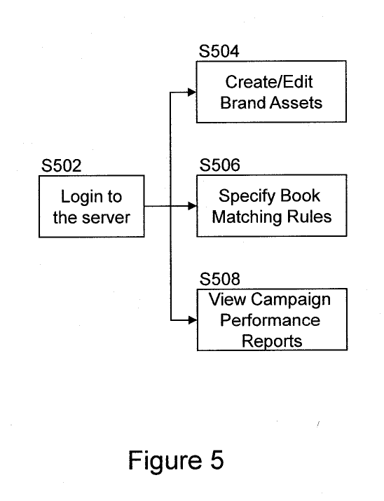

As illustrated in FIG. 5, at step S502 the server 18 enables the sponsors or their representative using devices 14 to login or connect to the exchange server 18 and at step S504 to create new brand assets including logos and advertisement images or modify any of the sponsor's existing brand assets. The sponsor's representative can create the brand asset images that will be inserted into one or more eBooks. The brand assets are created by uploading the pre-created images, colors, logos and text that identify the sponsors or by choosing any one of a number of templates and uploaded images to be inserted into that template.

At step S506 the sponsor's representative, using devices 14, specifies matching rules for eBook selection. The matching rules are similar to the above discussed targeting rules with the exception that they are directed to the needs and preferences of the sponsors. The matching preferences identify which eBook content is suitable for the brand. At step S508 the sponsor's representative is enabled to view performance reports of its campaigns. The campaigns are described below; however, it is noted that sponsorship campaigns may be created before or after the brand assets are added to the selected eBooks.

After receiving the brand assets and matching rules, the exchange server 18 matches enrolled eBooks and the brand assets based on the preferences supplied by the representatives of the sponsors and/or the publishers. Then the selected brand advertisements are added into appropriate determined locations of the selected eBooks. A design of a layout of the selected brand advertisements in the eBooks is automated, using for example pre-established algorithms (i.e., even distribution, random distribution, front-loaded distribution, etc.). In one embodiment sponsored eBooks are formed having brand advertisements inserted manually using the table of contents of the eBook as the design of the layout; placing the brand advertisements at chapter breaks. Specifically, placing the brand advertisements at chapter breaks is a good strategy for communicating brand messaging without interrupting reader flow. In another embodiment the brand advertisements can be inserted at various locations throughout the sponsored eBook randomly or in a predetermined pattern. The brand advertisements can take the form of full, half, quarter page advertisements or can be placed in page margins or elsewhere.

### Formation of Sponsorship Campaigns

The processed sponsored eBooks are then provided for sale to at least one eRetail system 16 (FIG. 3), such as Amazon Kindle store, Apple iBooks, Barnes and Noble Nook Store and any other eRetail system. The processed eBooks may also be returned to the publisher for sale in the publisher's own, or its representative's, eRetail store. Assuming that all brand assets to be used in the sponsorship campaigns are uploaded, the sponsored eBooks are then selected as part of a sponsorship campaign. FIG. 6a illustrates the server 18 enabling creation and management of the sponsorship campaign at step S602. Representatives of specific sponsors are limited to seeing only their own sponsorship campaigns.

FIG. 6b shows some of the campaign parameters, including start and end dates and the budget, that are entered in step S604 (FIG. 6a). Sponsored eBook titles are assigned to the campaign in step S606. As discussed above, the advertisements may be added prior or after formation of the sponsorship campaign. To form sponsored eBooks after formation of the campaign, in step S608 the advertisements are selected and assigned and in step S610 the layout of the advertisements in the selected sponsored eBook are finalized.

In one embodiment, at step S612 the server 18 (FIG. 2) enables specifying of purchase links on the eRetail systems 16 (FIG. 2). The server displays a list of eRetail systems that sell the sponsored edition of each eBook in a given campaign. For each eRetail system having an online website or site there will be a purchase link to buy that sponsored eBook. Additionally, the server can also enable specifying of promotion links. Similar to the above, the server displays a list of Promoter sites 20 (FIG. 2) that sell additional sponsored eBooks of the campaign. For each Promoter site there will be a promotion link. These links enable showing of when other, additional sponsored eBooks of the same campaign are clicked or their QR codes are scanned.

At step S614 details of rewards programs, if any, are specified. The rewards programs are optional incentives including entry for reward drawing contests. At step S616, the sponsored eBook complete with brand advertisements are formed and sent to the eRetail systems 16 (FIG. 2), and at step S618 the exchange server 18 enables viewing of various campaign reports.

### Campaign Start and End

As shown in FIG. 7a and discussed above to form a campaign, the server 18 matches particular eBooks to a brand sponsorship campaign (step S700). In a campaign, the sponsor (e.g., Nike) acknowledges its involvement and sponsorship of one or more eBooks to the readers, indicating that certain eBook titles (e.g., “The Long Run”) are being sponsored, and that the reader can obtain the sponsored eBooks, which include advertisements from the sponsor, for a subsidized price or in exchange for other economic benefits. The campaign also adheres to some surrounding rules about how it will be carried out, implying which titles are being sponsored; start and end dates of that sponsorship; the overall budget and the price paid per download or per ad impression, depending on the pricing model used; what creatives or advertising images will be used and how they should be distributed across the different eBooks in the campaign; and other features like a consumer rewards program, special data collection, etc.

As previously disclosed, sponsor's advertisements are placed into the eBook (step S702), which leads to formation of a completed promotional edition of the subsidized eBook (step S704). The representatives of the publishers of the sponsored eBook are notified about the completion of the process (step S704). At step S706 the representatives of the publishers of the sponsored eBooks in the campaign distribute the sponsored or promotional eBook edition to the eRetail systems 16 (FIG. 3). At step S708 the representative visits each eRetail system where the sponsored book is to be sold and places the sponsored eBook there. In response, at step S710 the participating eRetail systems activate the changes and begin to offer the sponsored eBook for sale.

The exchange server 18 (FIG. 3) does not set the price of the sponsored eBooks, instead it acts as an exchange to bring the publisher and the sponsors together to agree on the sponsorship subsidies for each title. The sponsor's representative using the device 14 (FIG. 3) offers a subsidy amount for a specific title or set of titles. This subsidy amount is negotiable and the communication between the sponsor's representative using the device 14 and the server 18 enables setting of, or coming to, an agreement on the subsidy amount. It is also possible to set higher or lower subsidy amounts for certain genres/categories. Alternatively, an auction may be established in which sponsors can bid on particular content for duration of a specific time period (e.g., Coca-Cola bids to sponsor “The Adventures of Huckleberry Finn” for Jul. 1, 2012 through Jul. 31, 2012).

The brand sponsorship campaigns are not open-ended—they are intended to run for a pre-set amount of time. The server 18 (FIG. 3) monitors each brand sponsorship campaign for each eBook title by periodically contacting the eRetail systems 16 and reviewing the sales data where available. To end the campaign the server 18 can withdraw the subsidized eBook from sale on the eRetail systems 16 (FIG. 3), or as shown in FIG. 7b, at step S720 the server 18 can send a notice to the representative of the publisher shortly before the end of campaign of a specific title. The end of campaign may be determined based on time or budget. At step S722 the server 18 monitors each eRetail system 16 and alerts the representative of the publisher if their sponsored eBook edition is not removed from sale on time. Additionally, at step S724 the exchange server 18 retrieves final sales data from each eRetail system 16 for each campaign of each sponsored title.

Once notified that the campaign is over, at step S726 the representative of the publisher using devices 12 (FIG. 3) removes sponsored eBook editions from each eRetail system 16 (FIG. 3). At step S728 the representative of the publisher accesses and reviews the sales data on the server 18 (FIG. 3). At step S730 the eRetail systems 16 complete the process by removing the sponsored titles, whose sponsorship campaigns have ended from their stores.

### CONCLUSION

To select and form an eBook to be subsidized in accordance with the preferred embodiment, the exchange server 18 (FIG. 3) receives eBook titles from the representative of the publisher and brand assets including logos and advertisement images from the representative of the sponsor and initiates an automated construction of a sponsored edition of the eBook. When requested by the sponsor through its representative, the exchange server 18 identifies a number of brand assets to be inserted in the eBook. This may be auto-calculated based on the price set to be charged per eBook sale.

In one embodiment the exchange server 18 (FIG. 3) matches the one or more eBooks to be subsidized to sponsors by executing an auction in which prospective sponsors bid for the period and for the amount of sponsorship. When the sponsor and the eBooks to be sponsored are matched, in one embodiment the branded eBooks are formed by identifying insertion points (e.g., chapter breaks) in the eBook's table of contents. The brand assets are then inserted into the eBook at the insertion points. The insertion points may be based on a particular strategy chosen or preferred by the sponsor (i.e., front, back, or even loaded). For each insertion point, the exchange server 18 generates an advertisement from a template and inserts it into the eBook, for example as a full, half, quarter page or in another form. Because insertion of advertisements may change position of the content within the eBook, the table of contents may be updated. For example, when the insertion points are positioned at chapter breaks the table of contents is updated to point to the insertion points rather than the first page of the chapter.

In accordance with the preferred embodiment, the exchange server 18 (FIG. 3) may form various versions of the same branded eBook title. Each version is then generated in each known format used by various available eBook reader devices having unique display properties.

At least one of the versions is then included by itself or with other branded eBook titles in a brand sponsorship campaign. For each brand sponsorship campaign the following acts are performed:
1) Determining a correct edition of each branded eBook for sale during the brand sponsorship campaign;
2) Assigning to each branded eBook edition a corresponding edition id or token by cross-referencing a database 30 (FIG. 3);
3) Identifying eRetail systems 16 (FIG. 3) where each branded eBook edition is intended to be on sale during the campaign;
4) At each eRetail system offering the branded eBook editions included in the campaign for sale:
   a) distributing the branded eBook editions to eRetail systems for a specified period as part of the campaign;
   b) searching for the branded eBook editions by ISBN, title and author;
   c) checking for the edition id in the eBook summary listed on the eRetail system's web page;
   d) periodically making a test purchase of the branded eBook editions, and
   e) checking a code present in the book for the correct campaign and edition id;
5) For each publisher whose branded eBook editions are included in the campaign: a) on a regular basis monitoring sales data at each eRetail system for the specific branded eBook editions, and b) aggregating sales data across all eRetail systems and branded eBook editions of the campaign, i) setting a threshold percentage of a campaign budget, and ii) alerting the publisher when the total sales figure reaches the threshold.

The publishers and the sponsors can cooperate to add cooperative marketing operation to generate sales. In accordance with the preferred embodiment, the exchange server 18 (FIG. 3) may:
1) identify overlapping incentives provided by the publishers and the sponsors on the eBooks involved in the campaign,
2) providing the publishers and the sponsors and/or their representatives with internal links (i.e., URLs) from third party network connected systems or websites 20 (FIG. 2) that promote the eBooks involved in the campaign, and
3) the publishers and the sponsors and/or their representatives sending promotional messages (e.g., emails, tweets, Facebook posts, or similar) promoting the eBooks in the campaign, the messages including the internal links to the promotional websites 20 about the eBooks in the campaign. The promotional websites 20 may include special offers, including options for purchase of other promotional eBook editions in the campaign.

Together with, or independent of, the campaigns, dynamic promotional offers and services may be presented to the readers of the eBooks that cannot natively present dynamic content. To this end the exchange server 18 (FIG. 3) is programmed to
1) generate QR codes, Bar codes, or any other code that includes information identifying a particular campaign in which the book is included or a promotion to which the reader may be entitled, the code is included into the eBook as part of or instead of the brand assets;
2) readers visiting a mobile landing page or an associated Internet website and presenting the codes;
3) via the landing page or the website, making available to the reader extended data about that scan including the eBook, edition, advertisement placement, and with an agreement from the reader additional reader specific information. The mobile landing page or the website may include current (dynamic) content and services made available by the sponsor and/or the publisher or other interested entities.
4) Further, rewards and prizes may be made available to the readers for actions specified after the readers present the codes.
   Additionally, a cooperative marketing operation among the publishers and the sponsors can be added to generate sales (e.g., of back listed eBooks).

Further, again together with, or independent of, the campaigns' reading progress and statistics pertaining to the eBook readers can be tracked, this is achieved:
1) Using QR codes, Bar codes, or any other code that includes information identifying a particular campaign in which the book is included or a promotion to which the reader may be entitled, the code is included in the eBook as part of, or instead of, the brand assets, to track reader progress in a book.
2) At reading time the reader interacting with the code included in the eBook, the interaction providing information indicating reader's progress. The exchange server 18 (FIG. 3) or a third party tracking service can then track the progress and make that data available to interested parties including the publishers and the sponsors.
3) The codes can also be used to the reader's advantage in another way. By interacting with the codes at the end of each chapter or elsewhere, the user can track his or her personal data over time to learn reading habits (e.g., name of titles read, the date an eBook was started or finished, the number of reading sessions, the pace of reading, how long it takes to read different eBooks, etc.). Some of the feedback the reader can get is the number of words in the read chapters and, therefore, words per minute read. Feedback can be provided on a webpage for access via a smart phone or desktop browser and may include information about start and stop of reading of an eBook and switch to a different eBook. The page may have a list of all eBooks the reader has read or owns and can switch among them. At every chapter break, or some other interval, the reader can interact with the codes to indicate that he or she now read to that new point. In response, the information on the page is automatically recalculated. Similarly, the data on the page can be made available to interested parties including the publishers and the sponsors.

### Hardware

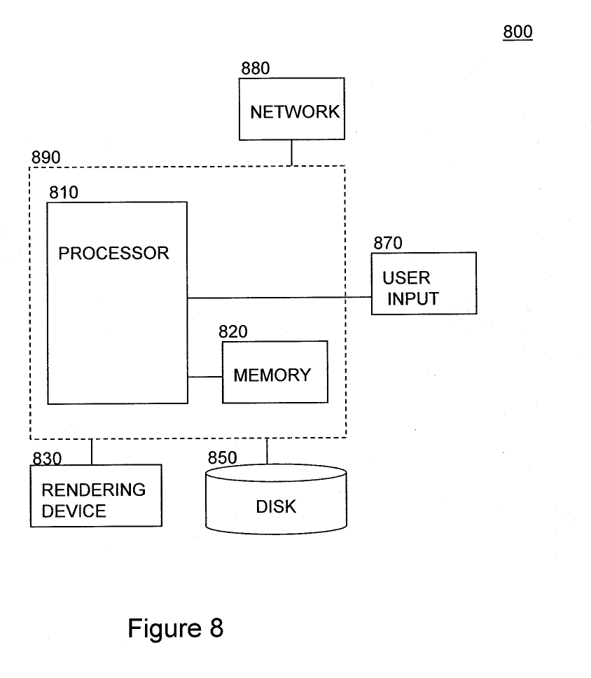

FIG. 8 shows a system 800 which represents an example of a computing device utilized to implement the server 18 as well as devices 12 and 14, and systems 16 and 20 (FIG. 2). The system 800 includes a user device 890 that has a processor 810 operationally coupled to a memory 820, a rendering device 830, such as one or more of a display, speaker, etc., a user input device 870 and a network 880 operationally coupled to the device 890. The application data and other data are received by the processor 810 and is used to perform operation acts in accordance with the present system and method. The operation acts include controlling at least one of the rendering device 830 to render one or more of the GUIs and/or to render content in accordance with the present system. The user input 870 may include a keyboard, mouse, trackball or other devices, including touch sensitive displays, which may be stand alone or be a part of a system, such as part of a personal computer, personal digital assistant, mobile phone, converged device, or other rendering device for communicating with the processor 810 via any type of link, such as a wired or wireless link. The user input device 870 is operable for interacting with the processor 810 including interaction within a paradigm of a UI such as a GUI and/or other elements of the present system, such as to enable web browsing, content selection, such as provided by left and right clicking on a device, a mouse-over, pop-up menu, radio button, etc., such as provided by user interaction with a computer mouse, etc., as may be readily appreciated by a person of ordinary skill in the art.

In accordance with an embodiment of the present system, the rendering device 830 may operate as a touch sensitive display for communicating with the processors 810 (e.g., providing selection of a web browser, a Uniform Resource Locator (URL), portions of web pages, etc.) and thereby, the rendering device 830 may also operate as a user input device. In this way, a user may interact with the processor 810. Clearly the user device 890, the processor 810, memory 820, rendering device 830, an optional disk 850 and/or user input device 870 may all or partly be portions of a computer system or other device, and/or be embedded in a portable device, such as a mobile telephone, personal computer (PC), tablet, personal digital assistant (PDA), converged device such as a smart telephone, etc.

The methods of the present system are particularly suited to be carried out by a computer software program, such program containing modules corresponding to one or more of the individual steps or acts described and/or envisioned by the present system. Such program may of course be embodied in a computer-readable medium, such as an is integrated chip, a peripheral device or memory, such as the memory 820 or other memory coupled to the processor 810.

The computer-readable medium and/or memory 820 may be any recordable medium (e.g., RAM, ROM, removable memory, CD-ROM, hard drives, DVD, floppy disks or memory cards) or may be a transmission medium utilizing one or more of radio frequency (RF) coupling, Bluetooth coupling, infrared coupling etc. Any medium known or developed that may store and/or transmit information suitable for use with a computer system may be used as the computer-readable medium and/or memory 820.

Additional memories may also be used. The computer-readable medium, the memory 820, and/or any other memories may be long-term, short-term, or a combination of long-term and short-term memories. These memories configure processor 810 to implement the methods, operational acts, and functions disclosed herein. The operation acts may include controlling the rendering device 830 to render elements in a form of a UI and/or controlling the rendering device 830 to render other information in accordance with the present system. The memories may be implemented as electrical, magnetic or optical memory, or any combination of these or other types of storage devices.

The network 880 should be understood to include further network connections to other user devices, systems (e.g., servers), etc. While not shown for purposes of simplifying the following description, it is readily appreciated that the network 880 may include an operable interconnection between processors, memories, displays and user inputs similar as shown for the user device 890, as well as networked servers, such as may host web sites, etc. Accordingly, while the description contained herein focuses on details of interaction within components of the user device 890 and other user devices and servers, it should be understood to similarly apply to interactions of other devices operably coupled to the network 880.

The processor 810 is capable of providing control signals and/or performing operations in response to input signals from the user input device 870 and executing instructions stored in the memory 820 or on disk 850. The processor 810 may be an application-specific or general-use integrated circuit(s). Further, the processor 810 may be a dedicated processor for performing in accordance with the present system or may be a general-purpose processor wherein only one of many functions operates for performing in accordance with the present system. The processor 810 may operate utilizing a program portion, multiple program segments, or may be a hardware device utilizing a dedicated or multi-purpose integrated circuit.

Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow.

The section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:
a) the word “comprising” does not exclude the presence of other elements or acts than those listed in a given claim;
b) the word “a” or “an” preceding an element does not exclude the presence of a plurality of such elements;
c) any reference signs in the claims do not limit their scope;
d) several “means” may be represented by the same item or hardware or software implemented structure or function;
e) any of the disclosed elements may be comprised of hardware portions (e.g., including discrete and integrated electronic circuitry), software portions (e.g., computer programming), and any combination thereof;
f) hardware portions may be comprised of one or both of analog and digital to portions;
g) any of the disclosed devices, portions thereof, acts, etc., may be combined together or separated into further portions, acts, etc., unless specifically stated otherwise;
h) no specific sequence of acts or steps is intended to be required including an is order of acts or steps indicated within a flow diagram; and
i) the term “plurality of” an element includes two or more of the claimed element, and does not imply any particular range of number of elements; that is, a plurality of elements may be as few as two elements, and may include an immeasurable number of elements.

What is at chapter breaks claimed is:

1. A method of one or more sponsors using a computing device connected to a network to subsidize one or more eBook titles, the method comprising acts of:
receiving one or more eBook titles and first descriptions of preferred sponsors from first representatives of one or more publishers;
receiving brand assets and second descriptions of preferred eBook content from second representatives of the one or more sponsors;
selecting based on the first and second descriptions at least one eBook title and at least one sponsor for sponsoring the at least one eBook title; and
inserting at least one advertisement formed on a basis of the brand assets received from the at least one sponsor into the at least one selected eBook title to form at least one sponsored eBook edition.

2. The method of claim 1, wherein
the brand assets include logos and advertisement images representing products and services identified with and supported by the one or more sponsors, and
the at least one sponsor determines what is included in the advertisement based on a subsidy amount for the at least one sponsored eBook edition and other considerations.

3. The method of claim 1, wherein the act of inserting comprises acts of:
identifying insertion points; and
inserting the at least one advertisement at the insertion points.

4. The method of claim 3, wherein the insertion points are chapter breaks retrieved from a table of contents of the at least one selected eBook title, and the at least one advertisement is selected from at least one of full, half, and quarter page advertisements generated for each insertion point, and
further comprising an act of updating the table of contents to point to the insertion points rather than the first page of the chapter.

5. The method of claim 3, wherein the insertion points are selected based on a strategy selected from one of front loading, back loading, and even loading.

6. The method of claim 1, further comprising an act of generating at least one version of the at least one sponsored eBook edition at least one format for display on at least on of a plurality of display devices capable of displaying eBook content.

7. The method of claim 1, further comprising acts of:
forming at least one brand sponsorship campaign to subsidize the at least one version during a period of sponsorship;
for the at least one brand sponsorship campaign
assigning to the at least one version a corresponding edition id, and
identifying one or more eRetailers connected to the network where the at least one version is to be on sale during the period of sponsorship; and
distributing the at least one version to the one or more eRetailers connected to the network, the eRetailers offering the at least one sponsored eBook editions for sale.

8. The method of claim 7, wherein the subsidy amount and the period of sponsorship are set by at least one of an auction and negotiation between the first and second representatives.

9. The method of claim 7, further comprising acts of:
one or more readers using one of the plurality of display devices
browsing, searching, and purchasing eBooks;
connecting to each other to view eBook bookshelves that include information about purchases of eBooks, when the purchased eBook was read, reader's comments, highlights, ratings, reviews, statistics related to the reading of the eBook and rewards,
sending recommendations for eBooks and receiving benefits when the recommended eBook is purchased in response to the sent recommendations; and
receiving rewards for reader's achievements including a number of words, pages, books read, a number of books from a certain category read.

10. The method of claim 9, further comprising an act of:
the one of the plurality of display devices:
storing eBooks on a cloud storage on the network;
resuming displaying the eBook from a page a reader previously stopped reading the eBook on the first or different one of the plurality of display devices;
enabling the reader to highlight the text of the eBook and store comments;
enabling the reader to view their reading progress statistics including words read per minute, pages read, time of reading, and number of reading sessions;
providing information on the author, title, and topics addressed in the book;
enabling the reader to share statistics of their progress and other collected information with other readers;
messaging other of the plurality of display devices;
display advertisements from promoters on margins of pages of the eBook being displayed;
receiving payments for the reader viewing the displayed advertisements; and
redeeming the payments at eRetailers.

11. The method of claim 7, further comprising acts of:
on each of the one or more eRetailers
searching for the at least one version using common eBook identifiers;
checking for the edition id in a summary of the at least one version; and
periodically checking a code present in the at least one version for correct campaign id.

12. The method of claim 7, further comprising acts of:
for each brand sponsorship campaign:
monitoring sales data of the at least one version at each of the one or more eRetailers;
aggregating the sales data across all of the at least one version and all of the one or more eRetailers;
setting a threshold amount of a campaign budget; and
alerting the publisher when the aggregated sales data reaches the threshold.

13. The method of claim 12, further comprising acts of:
identifying overlapping incentives provided by the one or more publishers and the one or more sponsors for the at least one version;
providing to the one or more publishers and the one or more sponsors internal links to common websites promoting the at least one version; and
the one or more publishers and the one or more sponsors sending promotional messages about the overlapping incentives to potential readers, the promotional messages including the internal links,
wherein the promotional websites comprise special offers including the option to purchase the at least one version.

14. The method of claim 7, further comprising acts of:
generating one or more codes having information identifying a reader and the at least one brand sponsorship campaign,
adding the one or more codes into the at least one version;
the readers visiting at least one mobile landing page and presenting the one or more codes; and
in response the at least one mobile landing page making available to the reader extended data including dynamic promotional offers presented by the one or more publishers and/or the one or more sponsors.

15. The method of claim 14, further comprising an act of using the one or more codes to track reading progress and statistics regarding the reader.

16. A method of one or more sponsors using a network connected computing device to sponsor one or more eBook titles, the method comprising acts of:
selecting at least one eBook title and at least one of the one or more sponsors for sponsoring the at least one eBook title by matching first description of a sponsor preferred by a publisher and a second description of eBook content preferred by a sponsor;
forming at least one sponsored eBook edition by inserting advertisement formed on a basis of the brand assets received from the sponsor into the at least one selected eBook title at insertion points based on a strategy selected from one of front loading, back loading, or even loading;
setting a sponsorship subsidy amount and a period of sponsorship;
generating at least one version of the at least one eBook edition;
forming at least one brand sponsorship campaign to sponsor at least one of the plurality of versions during a predetermined period; and
distributing the at least one version to at least one eRetailer connected to the network for offering the at least one version for sale during the predetermined period.

17. The method of claim 16, further comprising an act of receiving on the computing device the at least one eBook title and the first description from at least one representative of the publisher and the brand assets from at least one representative of the sponsor.

18. The method of claim 17, further comprising acts of:
identifying overlapping incentives provided by the publisher and the sponsor for the at least one version;
the publishers and the sponsors sending promotional messages about the overlapping incentives to potential readers, the promotional messages including internal links to common websites promoting the at least one version.

19. The method of claim 16, further comprising acts of:
adding one or more codes having information identifying a reader and the at least one brand sponsorship campaign into the at least one version; and
in response to the readers visiting at least one mobile landing page and presenting the one or more codes making available to the reader extended data including dynamic promotional offers.

20. A computer readable medium storing a non-transitory signal including computer readable code, which when executed by a computer performs a method of using a computing device connected to a network to subsidize one or more eBook titles, the method comprising acts of:
receiving one or more eBook titles and first description of preferred sponsors from first representatives of one or more publishers;
receiving brand assets and second description of preferred eBook content from second representatives of the one or more sponsors;
matching the first and second descriptions to select at least one eBook title for sponsorship; and
inserting at least one advertisement formed on a basis of the brand assets received from the at least one sponsor into the at least one selected eBook title to form at least one sponsored eBook edition.
